(19) United States
(12) Patent Application Publication
(10) Pub. No.: US 2026/0289620 A1
(43) Pub. Date: Sep. 24, 2026

(54) CANONICAL PRODUCT CATALOGUING SYSTEM

(71) Applicant: Flywheel Dynamix, Danville, CA (US)

(72) Inventors: Anil Koppisetti, Pleasanton, CA (US); Ankur Srivastava, Danville, CA (US)

(21) Appl. No.: 19/575,473

(22) Filed: Mar. 23, 2026

Related U.S. Application Data
(60) Provisional application No. 63/776,774, filed on Mar. 24, 2025.

(51) Int. Cl. G06Q 30/0601; G06Q 10/087

(52) U.S. Cl. CPC G06Q 30/06031; G06Q 10/08726

(57) ABSTRACT

A technique for cataloging Cloud procurement marketplace is disclosed that addresses problems such as vendor name ambiguity, product family disambiguation, and duplication. A universal unique identifier accounts for differences in vendor name aliases and product naming across different Cloud procurement marketplaces. A product information management system monitors changes in different Cloud procurement marketplaces. The universal unique identifier can be utilized for searching across Cloud procurement marketplaces and for generating trackable information throughout the procurement process.

### CROSS REFERENCE TO RELATED APPLICATIONS

The present disclosure claims the benefit of U.S. Prov. Pat. App. No. 63/776,774, filed Mar. 24, 2025, entitled “System and Method For Cloud Procurement Meta-Marketplace”.

### TECHNICAL FIELD

The present disclosure is generally related to a technology for addressing problems of cataloguing and searching across Cloud product platforms including problems such as vendor name ambiguity, product family disambiguation, duplication, and staleness.

### BACKGROUND

Cloud procurement encompasses a wide variety of activities and is more complex than ordinary e-commerce. Cloud procurement refers to acquiring software, services, and technology solutions vendors through the Cloud marketplace platforms to enable enterprise organizations to discover, purchase, and deploy third party software. Cloud procurement in general is more difficult than ordinary e-commerce, particularly for the software procurement. For example, software procurement for Enterprise buyers can include CSV files to find qualified vendors (e.g., sellers) and negotiate terms for data, IT services, and software services. An alternative to CSV files is data retrieved using various standard procurement or IT management systems, but this is often complex to implement. There may, for example, be license terms and compliance issues to negotiate.

There is a fragmented Cloud procurement marketplace. Some of the major Cloud procurement marketplaces include Amazon Web Services (AWS®), Microsoft Azure®, and Google Cloud Platform (GCP®). Could buyers face an overwhelming variety of options across solutions and platforms, often navigating complex choices without sufficient insights. For example, AWS® procurement can include acquiring software, services, and technology solutions from vendors through the AWS® marketplace to enable enterprise organizations to discover, purchase, and deploy third party software. Finding relevant products across all the different marketplaces is a problem. There are additional complexities for buyers such as dealing with license management and dealing with FP&A systems. However, it's difficult for buyers to optimize their procurement decisions over multiple Cloud procurement marketplaces. The different Cloud Procurement systems are incompatible with each other and are largely isolated systems.

### SUMMARY

A technology to generate Universal Unique Identifiers (UUIDs) is disclosed for cataloguing different Cloud product catalogs and creating unified listings and cross-platform search capabilities. A canonical catalog supports searching across cloud product catalogs of different Cloud marketplaces. A product information management system address problems of vendor name ambiguity, product family disambiguation, duplication, and stale entries. The UUID's supported query matching across different Cloud procurement platforms. The system accounts for differences in workflows and APIs between different Cloud marketplaces. The universal unique identifier can be utilized for searching across Cloud procurement marketplaces and for generating trackable information throughout the procurement process. The UUIDs may also be used to support new procurement services.

### BRIEF DESCRIPTION OF THE DRAWINGS

FIG. 1 is a block diagram illustrating aspect of a system for generating universal unique identifiers to support cataloging and searching product listings different Cloud procurement platforms and providing new services in accordance with an implementation.

FIG. 2 illustrates an example of a meta-marketplace having unified listings in accordance with an implementation.

FIG. 3 illustrates an example of an alternate implementation of a seller registering to use intelligent product display pages in accordance with an implementation.

FIGS. 4A and 4B illustrate aspect of using the universal unique identifiers to support private offer procurement in accordance with an implementation.

FIG. 5 illustrates an example implementation using a buyer hub, a seller hub and an integration/orchestration engine accordance with an implementation.

FIG. 6 illustrates an example of multi-tier private offer orchestration in accordance with an implementation.

FIG. 7 illustrates an example of a product information management system in accordance with an implementation.

FIG. 8 illustrates measures to ensure a high degree of accuracy and reliability of a LLM used to generate enriched data for generating universal unique identifiers in accordance with an implementation.

FIG. 9 illustrates an example sequence of actions to detect and generate a new universal unique identifier in response to changes in a cloud product catalog in accordance with an implementation.

FIG. 10 illustrates an example multi-level normalization in accordance with an implementation.

FIG. 11 is a flow chart illustrating an example of a process to generate a new universal unique identifier in accordance with an implementation.

FIG. 12 illustrates an example of a universal unique identifier in accordance with an implementation.

FIG. 13 illustrates an example of a UUID data model.

FIG. 14 illustrates an example application of a UUID matching engine in accordance with an implementation.

FIG. 15A illustrates an example of a combination of an intelligent product display system and an intent classification engine in accordance with an implementation.

FIG. 15B illustrates an example of a multi-stage recommendation engine in accordance with an implementation.

FIG. 16 is a flow chart illustrating an example of Vendor retargeting in accordance with an implementation.

FIG. 17 is a flowchart illustrating an example of new procurement services in accordance with an implementation.

FIG. 18 shows an example of a UUID Platform architecture in accordance with an implementation.

FIG. 19 shows a component view of the platform architecture in accordance with an implementation.

### DETAILED DESCRIPTION

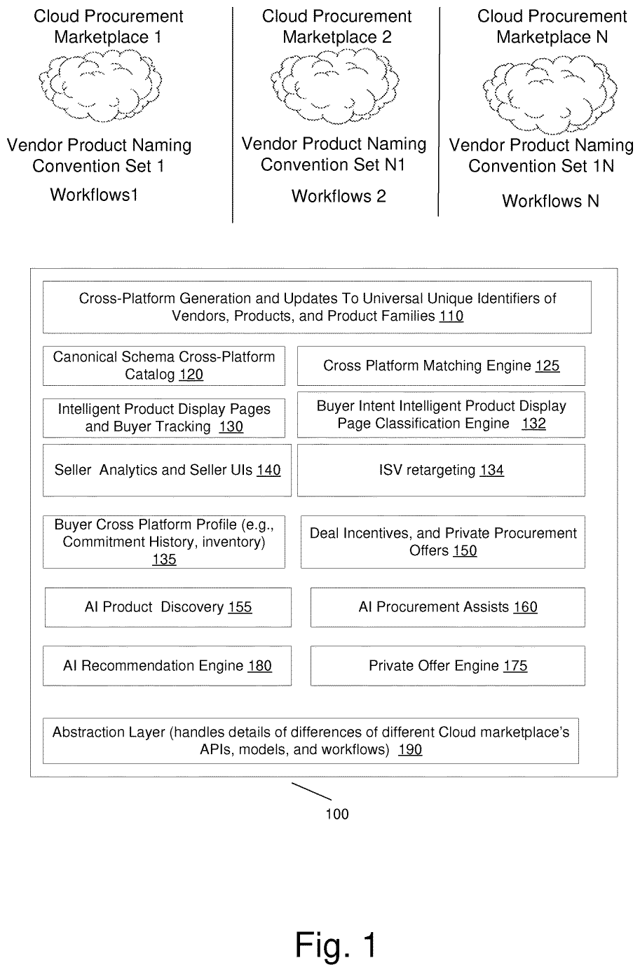

FIG. 1 illustrates, at a high-level, how there may be a number N of different Cloud marketplace platforms. For the purposes of illustration, three Cloud procurement marketplaces are illustrated, which may correspond to examples like AWS, Azure, and GCP, although more generally there may be an arbitrary number of different Cloud procurement marketplace platforms. Examples of sellers include independent software vendors (ISVs), service providers, and advisories. Examples of buyers include IT leaders, procurement leaders, and finance leaders.

Each Cloud marketplace has different vendor naming conventions and different product naming conventions. Each Cloud marketplace also has different buyer and seller workflows for deal workflows and private offer workflows. Each Cloud marketplace platform is effectively an isolated system with different APIs, different data models, different workflows, and different (limited) analytics.

A meta-marketplace system 100 is disclosed that supports buyers searching for and making procurement transactions across a meta-marketplace that encompasses two or more different Cloud marketplaces. There is the generation, maintenance, and updating of cross-platform universal unique identifiers (Cross Platform UUIDs) of vendor names, vendor name variations (aliases), vendor products, and vendor product families as illustrated by block 110. UUIDs also go by the name given by the inventors of “FUID” for a Flywheel Unique identifier. Flywheel Dynamix, Inc., is the assignee of the present disclosure. Flywheel Dynamix, Inc. is also illustrated in some drawings as “Flywl” and “FD”).

Information about the vendor names, product names, and product families on different Cloud marketplace may be acquired in different ways, including scraping data, accessing public sources of information (e.g., via an artificial intelligence engine such as a large language model (LLM). In some cases, Cloud marketplace APIs may be accessed, in for example, partnership relationships.

A UUID associates vendors names, vendor name variations (aliases), relationships with vendor products, vendor product families, and product IDs. A UUID is a unique ID that aids in identifying relationships between vendor names (and vendor name variations) with vendor products and product IDs. A UUID may include a vendor name, Unique ID, a Product ID and other Identifiers. the UUID and associated relationship information may be stored (e.g., in a table format or other mapping format) and later used to access relationships between vendor names, vendor products, and other ID information.

In one implementation, the UUIDs are used as references carried throughout the transaction process into the cloud marketplaces and into the procurement and finance systems (like the purchase order numbers which are used to reconcile the marketplace spend in the FP&A systems). The UUIDs thus support new uses in cloud procurement that were previously not possible.

As illustrated in block 120, a canonical cross-platform catalog uses a schema based on the UUIDs. A cross platform matching engine 125 uses the UUIDs and the canonical cross platform catalog to respond to queries and identify vendors and products on different Cloud marketplace platforms.

Block 130 illustrates product display pages with buyer tracking, wherein the tracking may be across vendors, products and product families. In some implementations, sellers register their products for tracking and product display pages are generated that are tagged for tracking. Block 132 is for an intelligent product display page system that includes an intent classification engine to capture buyer signals, classify buyer intent. It supports retargeting of ISVs (block 134) and enablement by ISVs.

In some implementations, a cross-platform buyer profile 135 is created. The cross platform buyer profile may, for example, store information about commitments a buyer has with different cloud marketplaces, the buyer's inventory, and information about previous procurement history, although more generally any information could be included in the buyer profile that is useful for generating product recommendations, and assisting buyers to obtain incentives and deals.

Seller analytics, seller UIs and dashboards 140 may be provided. As illustrated in block 150, deal incentives and private procurement offers 150 may be supported. An AI product discovery engine 155 may be provided to support AI product discovery for buyers. AI procurement assists 160 may be provided. A private offer engine 175 may be provided to manage private offers. An AI recommendation engine 180 may be provided to generate recommendations.

An abstraction layer 190 is provided to handle differences in Cloud marketplace APIs, models, and workflows. The abstraction layer 170 hides from users the details of various complex information management processes. The abstraction layer interacts and transacts on the different marketplaces (e.g., AWS®, GCP®, and Azure)®, Each Cloud marketplace platform differs, not just in APIs, but in data models, terminology, authorization flows, offer structures, entitlement mechanisms, and financial reporting formats. As an example of how the abstraction layer simplifies operations, it can be implemented to support unified authorization workflows.

In contrast, conventionally managing authorizations and entitlements across three marketplaces require separate dashboards, separate credential management, and separate processes in different Cloud marketplaces (e.g., AWS®, GCP®, and Azure®). The abstraction layer also supports new workflows. This includes, as an example, Cross-Marketplace Financial Planning and Accounting (FP&A) Reconciliation: This is a new workflow that does not exist in any current procurement tool. Today, FP&A teams reconcile cloud marketplace spend manually by downloading reports from each marketplace portal, cross-referencing vendor names (which differ across marketplaces), and manually mapping to internal cost centers. This is error-prone and time-consuming.

### Example Meta-Marketplace Implementations

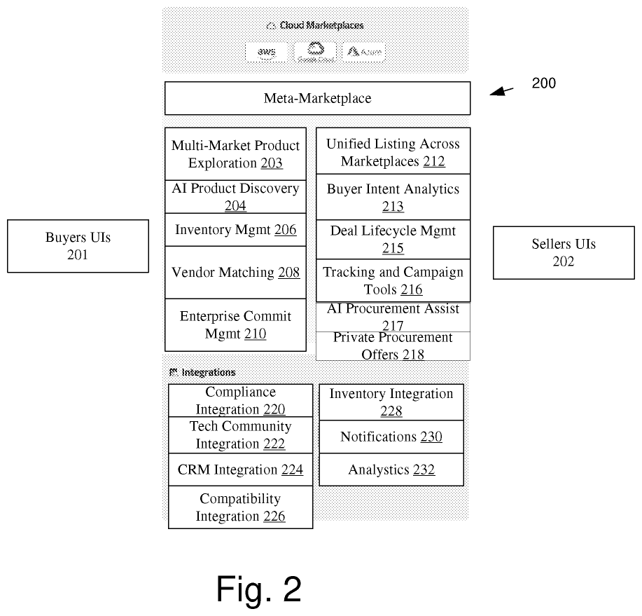

FIG. 2 illustrates some of the major functional blocks and services that are supported by a meta-marketplace 200, showing buyers 201 and sellers 202. The buyer 201 accesses access the meta-marketplace through UIs. Sellers 202 also have the option to use UIs to access the meta-marketplace. As discuss later in more detail, the UUIDs are leveraged to create what is in effect a cross-platform catalog of product listings. The UUIDs support shaving a unified listing across marketplaces 212 and supports multi-market product exploration 203 by buyers. The technology for creating unified listing across marketplace supporting multi-market product exploration leverage off of the UUIDs, which can be used to create what is effectively a cross-Cloud platform catalog of listings. The UUIDs can also be carried throughout the procurement process. The use of an abstraction layer also aids in supporting new services.

FIG. 2 illustrates a partial set of example services supported by the UIIDs. AI product discovery 204 may be supported to aid buyers to discover products and procurement recommendations based on various factors, such as the buyer's previous procurement decisions across different Cloud procurement platforms. Inventory management 206 may be provided to, for example, map a buyer's previous procurement decision to the UUIDs. Vendor matching 208 includes generating a match based on a buyer's queries and/or CVS files. As discussed later, a matching engine may be included. Enterprise Commit management 210 may monitor a buyer's procurement commitments for different Cloud marketplaces. Managing commitments while optimizing other procurement decisions can be difficult for Enterprise buyers.

In block 213, buyer intent analytics are determined from the interaction of buyers with intelligent display pages, although more generally other factors could be considered, such as previous procurement decisions and other sources of information.

Deal lifecycle management 215 may be provided to manage a deal lifecycle for an individual seller seeking to make a deal with a particular buyer (e.g., a buyer seeking the seller's product and exhibiting behavior associated with an intent to buy). Tracking and campaign tools 216 may be included. In some implementations, tag management of intelligent product display pages is used to track buyers as they view the intelligent product display pages (e.g., using Google Tag Manager (GTM®) or other tracking technologies). For example, the intelligent product display pages for an ISV may be campaign pages by the ISV. An AI procurement assistant 217 may be provided to aid a buyer to navigate complex procurement flows. Private procurement offers 218 may be supported.

In some implementations, integrations are supported with other services, although more generally additional services could be built into the meta-marketplace system 100. In FIG. 2, some example integrations include compliance integration 220; tech community integration 222; Customer Relationship Management (CRM) integration 224; compatibility integration 226, inventory integration 228; notifications 230; and analytics 232. Integrating multiple services into the meta-marketplace supports providing new cross-platform services.

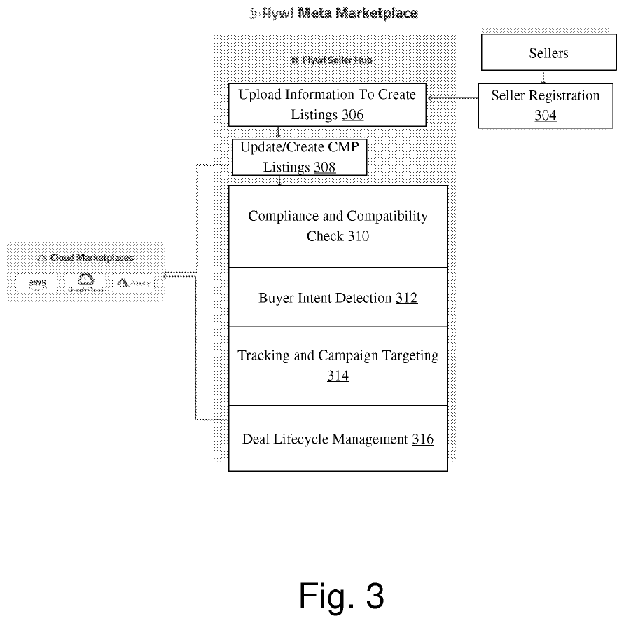

Referring to FIG. 3, in some implementations, sellers have the option to register 304 and get verified on the meta-marketplace. Sellers upload information on their vendors and products to create listings 308 as intelligent product display pages that may be tagged and tracked. In some implementations, consent management platform (CMP) listings are generated 308. A compliance and compatibility check 310 is performed in a seller's hub. The seller's hub supports buyer intent detection 312, tracking campaign tracking 314, and deal lifecycle management 318. In some implementations, GTM® & Campaign creation is supported to create dynamic segments & targeted campaigns. GTM tools may be used to engage leads. Deal lifecycle management 316 is supported, such as to manage leads, private offers, and get notifications.

In some implementations, of the meta-marketplace, the meta-marketplace supports ISV campaigns, as discussed later in more detail, as well as ISVs receiving information on buyer intent.

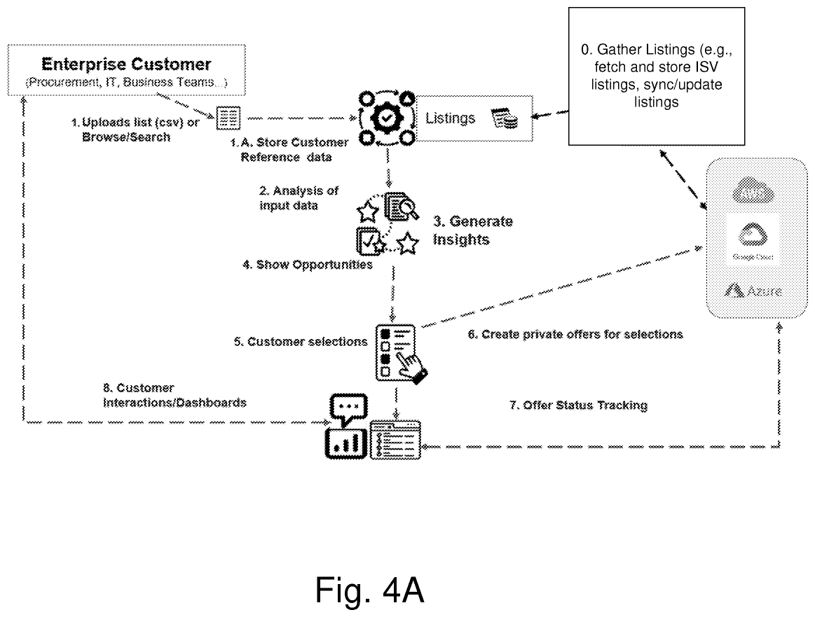

Conventional Cloud marketplaces have very limited workflows and do not support cross-marketplace private offers. FIGS. 4A and 4B illustrates an example of a private offers in accordance with an implementation for an example implementation. FIG. 4A illustrates the steps at a high level. FIG. 4B illustrates the same basic steps in more detail. As previously discussed, the meta-marketplace has UUIDs generated to identify vendor name, vendor name aliases, and vendor products and product families. The meta-marketplace has a canonical cross platform catalog. Intelligent product display pages support tracking of buyers and determining buyer intent. Sellers may also register to support private offers. In step 0, listings are gathered, which may include fetching and storing ISV listings. In one implementation of step 1, an enterprise customer uploads a current list in a template with mandatory fields or performs a browser search. Customer reference data is stored in step 1a. In step 2, searching matching rules are defined to ensure consistency and maintenance for the analysis of input data. In step 3, the generation of insights may include insights such a total matched, total not matched, found at particular Cloud service providers (e.g., AWS GCP, Azure, etc.), total expired, total new, etc. Note that various integrations may be supported to support generating listings from different sources. In step 4, opportunities are shown to a buyer, such as renewals and the choice of providers; or new alternate selections with choice of providers. In step 6, private offers for selection are created that may include Channel Partner Private Officer (CPPO) flows for each Cloud marketplace. In step 7, offer status tracking may be performed automatically using API updates but may in some implementations also include manual negotiations with support provided to capture all data. In step 8, customer interactions may include dashboards for administrative purposes.

### Example Multi-Tier Implementation for Private Offer Orchestration

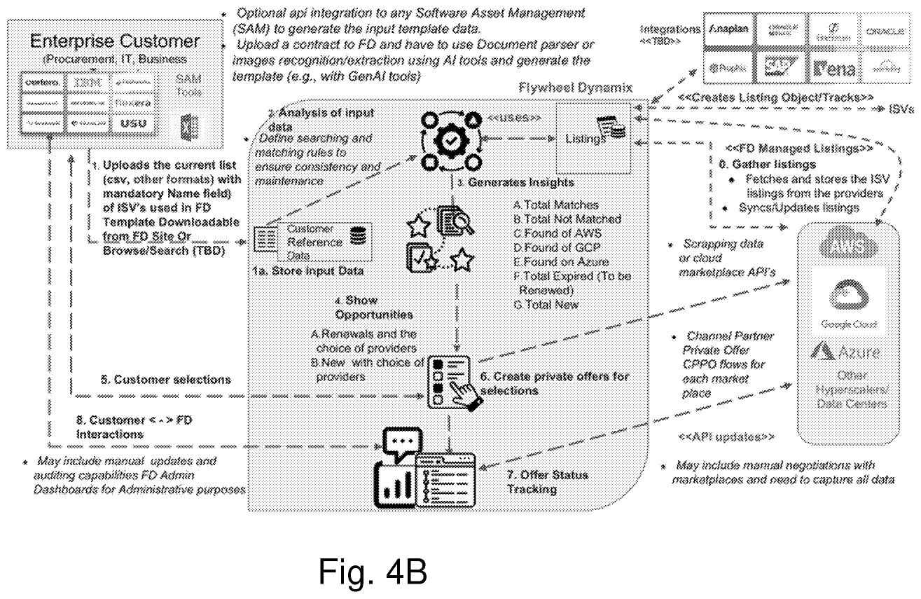

Referring to FIG. 5, the meta-marketplace may be implemented in different ways. In one implementation, there are three hubs corresponding to three (or more) different tiers of functions for implementing services such as private offers. The multi-tier implantation includes at least three hubs. This includes a buyer hub platform (known in a commercial implementation as “Compass”) 502, an integration hub/orchestration engine (corresponding in a product implementation to “Nexus”) 504, and a seller hub platform 506 (known in a commercial implementation as “Beacon”).

Compass (Buyers) and Beacon (Sellers/ISVs) are the customer facing application of an example implementation of the meta-marketplace. Nexus is an internal application for orchestration. As discussed later, there may also be a core platform 508. Agentic AI 510 may also be supported to aid in providing certain services.

In some implementations, the buyer hub 502 includes procurement workflows, spend modeling and FinOps, inventory management, enterprise commitments, and AI deal assists. For example, the buyer hub (Compass) may support centralized procurement across different Cloud marketplaces, AI-powered deal assistance and spend optimization, automated inventory management, renewals, FinOps visibility with commitment tracking, Enterprise SSO and compliance workflows, and real time incentive and credit surfacing.

In some implementations, integration hub/orchestration engine (Nexus) 504 includes marketplace API integrations 514, Hubspot deal ingestion, CRM data sync, Business Intelligence (BI) and dashboarding; and cross platform orchestration 516.

In some implementations, the seller hub 506 includes account management, incentive campaigns, private offer campaigns, analytics dashboard, and reseller authorization. The seller hu (Beacon) can include account health monitoring and estate management, incentive campaigns to drive buyer transactions, private offer creation across marketplace, reseller authorization and deal tracking, seller analytics dashboard, and customer relationship management integration.

Buyer intent capture may be performed in the buyer's hub (Compass). The buyer hub captures buyer intent including product selection, quantity, preferred marketplace, commitment context, and desired pricing. It leverages AI Deal Assist and intelligent product display pages (IPDP) intent signals.

It will be understood the three hubs may also be implemented in other ways than those described. It will also be understood that an overall meta-marketplace solutions support other functions, as previously discussed, which may be performed in the integration hub/orchestration engine 504 or in a backend system, depending on implementation details. This may include, for example, discovering, verifying and maintaining a cross-marketplace catalog based on canonical UIIDs of vendor names, and relationship with vendor products and vendor product families 518. Support may be provided for AI recommendations, deal assistance, incentives, and FinOps with commitment tracking 525 Support for private offer orchestration 530 may be provided. A cross marketplace matching engine 535 may be provided. Other integrations 540 may be supported, such as with software asset system, license management system, FP& A systems, etc.

The integration hub/orchestration engine (Nexus) translates agnostic offer parameters into marketplace-specific API calls for AWS, Azure, or GCM. It Handles routing, to the optimal marketplace incentive optimization, and tracks offer status. Nexus h

The seller hub (Beacon) gives ISVs and channel partners a unified dashboard for managing offers across all marketplaces, including reseller authorization and deal tracking.

The buyer hub platform (Compass) may be used by a buyer to browse UUID products. In some implementations, an AI deal assistant can make recommendations to the buyer. In some implementations the commitment context of the buyer is used to make recommendations to the buyer. The procurement path may be selected.

In some implementation, marketplace routing for procurement is provided by Nexus. In some implementations, Nexus checks ISV authorization status. Individual authorizations may be provided by ISV to provide private offers to the buyer.

In some implementations, Nexus evaluates available incentives: marketplace-specific programs (e.g., AWS® ISV Accelerate), ISV-specific incentives configured in Beacon, channel partner pricing, and meta-marketplace platform credits.

In some implementations, Compass provides recommendations when Buyers do their financial modeling. The buyer can accept the recommendation or choose their own as needed. In some implementations, intent capture and qualification is performed by Compass. In some implementations, the buyer uploads an inventory of SaaS contracts and the marketplace system 100 matches the products cross-marketplace availability which then analyzes the buyer's commitment balances (EDP remaining, MACC remaining, GCP committed use remaining) and surfaces contextual recommendations.

In some implementations, if the buyer signals transactional intent (e.g., clicks “Request Private Offer” or “Get Quote”), the system captures the specific product UUID, desired quantity/duration, and preferred marketplace.

In some implementations, offer configuration and translation is performed by Beacon and Nexus. An ISV provides authorization from Beacon, where in some implementation the ISV's configures offer terms in Beacon using a unified form that abstracts marketplace-specific fields: pricing, duration, payment schedule, custom terms. In some implementations, Nexus translates the unified parameters from the unified form into marketplace-specific API calls. As some examples, the translation for AWS a CPPO is created via the AWS Marketplace Catalog API, setting pricing dimensions, offer expiry, and buyer account ID. As another example, for Azure the translation from ISV-to-Customer or MPO can be created via the Partner Center API, configuring Plans, pricing tiers, and the customer tenant ID. For GCP, the process of translation can Creates a Private Offer via the Partner Procurement API, setting the plan, pricing, and buyer billing account. Each marketplace API has different required fields, validation rules, and error handling. Nexus manages this complexity, presenting a unified success/failure status to the Seller/Buyer.

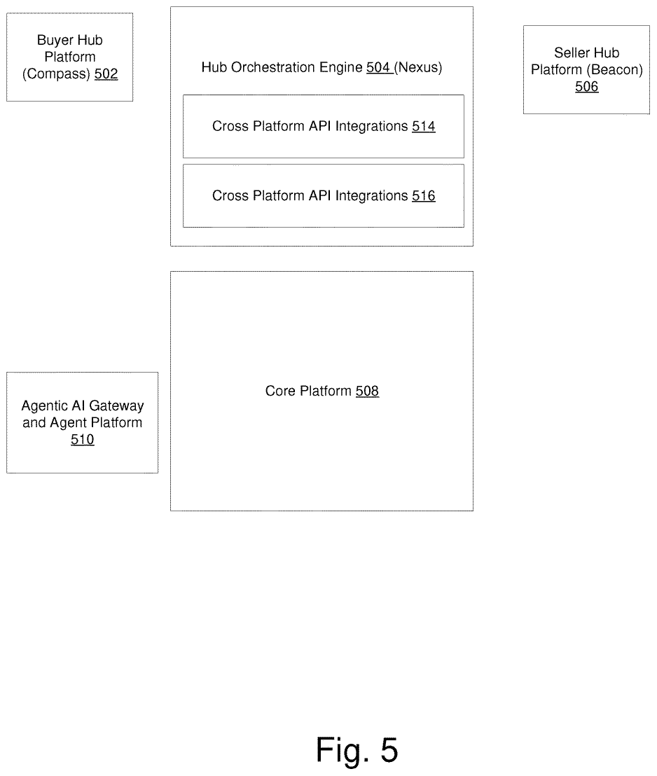

And example of a three-tier private offer orchestration is illustrated in FIG. 6. The first tier is associated with the buyer's activities. This includes intent buyer capture 600. The buyer browses UUID products. The user may receive AI deal assist recommendations 604. In some implementations, the commitment context 606 is used to provide recommendations. At 608, the procurement path is selected by the buyer. At tier 2, the actions are with regard to the orchestration engine (Nexus) 610. The orchestration engine translates to marketplace APIs. In some implementations, it routes to a customer selected marketplace 614. At 616, the orchestration engine performs incentive optimization. At 618, the orchestration engine tracks offer status. At tier 3, for the seller hub (Beacon) 620, at 622 the seller hub aids a seller to configures offer terms. At 624 the seller hub manages reseller authorization. At 626 it performs cross-marketplace tracking. At 628 deal room negotiation is supported by a private offer, which can encompass various parties including buyers, sellers, a team from the meta-marketplace or even Hyperscaler account teams as necessary. As illustrated at 630, 632, and 634, the private offer orchestration can be performed for different cloud procurement marketplaces with different private offer APIs and workflows.

### Example Product Information Management System Generation of UUIDs

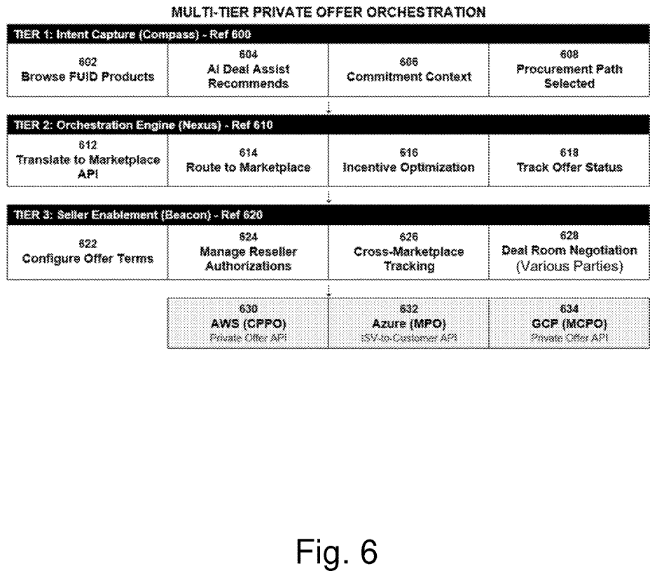

Referring to FIG. 7, UUIDs may be generated using a product information management (PIM) system 720 with a PIM backend 725 to perform services for the generation and updating of UUIDs. For example, as new vendor names/product names are encountered in different cloud marketplaces (or by vendor registration), the UUID can be incremented to create a new UUID. In some implementations, the generation of a new UUID includes several stages to ensure accuracy. The PIM system architecture utilizes a shared schema, based on the UUIDs. The UUIDs support cataloging Vendors, Product Families, and Product Listings across different Cloud product catalogs.

The PIM system may be implemented in different ways, but a PIM backend 724 staging-to-approval pipeline 716 for UUIDs. The staging pipeline 716 may include a human review that includes human review interface. Alternatively, a catalog manger UI 723 may be provided. The PIM backend 725 may house Create, Read, Update, and Delete (CRUD) and orchestration APIs 721. The PIM backend 725 may include UUID generation 722.

Batch ingestion 702 of files for candidate UUID information, parsing 704, and multilevel normalization 706 of newly detected (or updated) information on vendors/vendor products may be performed. The PIM system 602 may include a drift detector, which may be implemented as a delta analyzer to determine the difference between a Cloud product catalog (e.g., AWS®, Azure®, GCP®) and a canonical product catalog based on the UUIDs. For example, the drift detection may be performed on a scheduled basis or on demand to identify new or changed entries. In some implementation, an AI enrichment engine 714 includes large language model (LLM) agent that takes raw vendor names and enriches this raw information by discovering legal names, website logos, product families and aliases. A variety of different LLMs may be used, including examples such as Perplexity. An LLM may be selected based on its accuracy and reliability at performing enrichment.

The prompt structure of the AI enrichment engine 714 may include guardrails and verifications of the LLM output to ensure a high level of accuracy and reliability. Approved changes (by a human revers) to the canonical catalog may be implemented by a database (DB) broadcaster subsystem 726.

Catalog management 740 is provided for overall management responsibilities of the catalog 745.

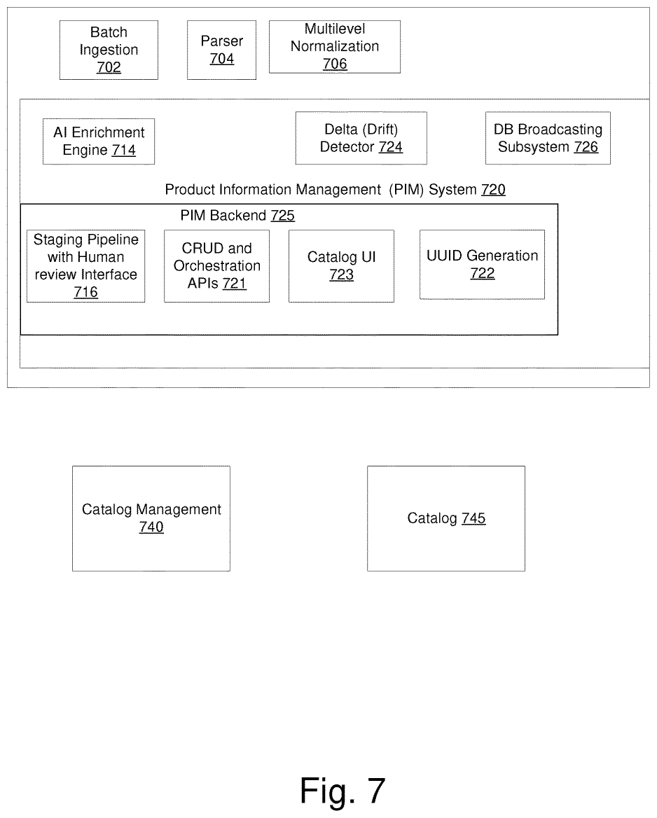

FIG. 8 illustrates some of the components of the PIM system with an emphasis on the AI enrichment engine 714. The UUID in one implementation is associated with the human-verified legal name, website, and logo that resolves all marketplace naming variants for the Vendors. The LLM enrichment engine 714 may include prompt guardrails, cross-reference verification, and other measures to improve the reliability of the AI enrichment. Moreover, human-in-the loop to provide a final review and approval of each new UUID is an additional important measure for reliability and accuracy. A human in the loop, for example, can reject, accept, edit, or approve a UUID.

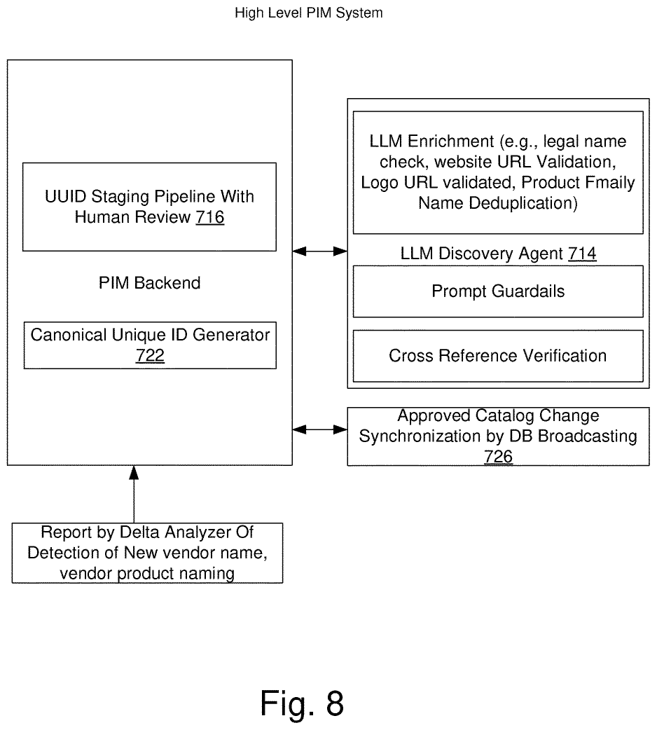

FIG. 9 illustrates the delta analyzer monitoring a cloud product catalog. The Delta Analyzer calculates the difference between the data of each cloud marketplace catalog that it is monitoring (e.g. AWS®, Azure®, GCP®) and the canonical product catalog. It operates periodically (e.g., weekly) or on-demand reports identifying new or changed entries. It generates a delta report of new or changed vendor names/product relationship for the PIM to review. It generates reports of new or changed entries and feeds them back into the PIM pipeline for enrichment and review. This creates a closed loop where our catalog continuously absorbs marketplace changes through the same curated process.

The PIM system addresses several problems. One of these Vendor Name ambiguity, in which the same company may have different names. Cloud marketplaces or procurement systems, or CRM systems use inconsistent vendor naming. The same ISV may appear as “Palo Alto Networks” on AWS, “Palo Alto Networks, Inc.” on Azure, and “Palo Alto Networks” on GCP. Without a process to generate a UUID, these differences would be treated as three separate vendors, which means: that a buyer searching for Palo Alto products sees fragmented results across marketplaces. This in turn leads to problems in providing services. For example, if there is inconsistent vendor naming, then private offers cannot be compared across providers because the vendor identity is not linked. As another example of a problem caused by inconsistent vendor naming, enterprise commitment tracking misattributes spend if it cannot recognize the vendor is the same entity.

The use of an LLM Agent to generate enriched data solves this problem by discovering the legal name, known aliases, website, and logo for each raw vendor entry. The human reviewer then confirms or corrects this enrichment before UUID is assigned. This means a single UUID ties together all marketplace-specific aliases for one canonical vendor identity.

The use of the LLM enrichment also addresses the problem of product Family disambiguation. A single vendor may sell dozens of products across marketplaces, but the product names differ. For example, an ISV might list “Enterprise Security Suite” on AWS and “Advanced Threat Protection-Enterprise” on Azure. These are the same product family but would never match through simple string comparison. With the help of LLM Agent, there is enrichment of each vendor with known product families and aliases. The staging review workflow lets a human reviewer (e.g., a Catalog Manager) manually link product families that the AI may not confidently match. This semi-automated approach with humans in the loop handles the long tail of ambiguous product names that fully automated systems miss.

Having humans in the loop also addresses a potential problem of duplicate UUIDs. When the Delta (drift) Analyzer detects a new vendor on a cloud marketplace, it may be a legitimate new ISV, a renamed version of an existing vendor, or a subsidiary/acquisition of a known vendor. Without the human review gate, automated systems would create duplicate UUIDs for what is actually the same entity. The staged-to-canonical pipeline. In some implementations, when a potential new vendor is flagged by the Delta Analyzer, the human catalog manager can: (a) approve it as genuinely new, (b) reject it as a duplicate of an existing canonical vendor, or (c) ignore it as a non-software entity (hardware-only, for implementation in which there is no procurement of hardware). This prevents namespace pollution and ensures UUID uniqueness.

In some implementations, an option is provided to generate UUIDs for software vendors but not hardware vendors. Cloud marketplaces list both software and hardware vendors. In software procurement implementation, when the LLM Agent enriches a vendor and determines it is hardware-only (e.g., networking equipment), the human catalog manager can mark it as IGNORED, which moves it to the Ignored Vendor table with a reason code (NON_SOFTWARE_VENDOR, INVALID_DATA, OTHER). These vendors never receive a UUID, keeping the namespace clean and focused.

The UUID, in combination with an understanding of the semantic relationships between different data models used by different Cloud procurement marketplaces, solves problems in marketplace listing format Inconsistencies. Each cloud marketplace structures product listings differently. For example, AWS® uses a flat listing model with AMI/SaaS/Container categories. Azure uses Plans within Offers within Publishers. GCP® uses a Solution/Product hierarchy. The UUID supports a matching engine mapping across different Cloud marketplace platforms and their associated data models. For matching engine for three different Cloud marketplace must normalize across these three fundamentally different data models to produce the seven-category output, which results in various possibilities such a no match on any of the Cloud marketplace, matches for one or more, etc. This requires understanding the semantic relationships between how each marketplace organizes its catalog.

The Delta analyzer ensures the canonical catalog stays current by comparing cloud marketplace data against the canonical catalog. It generates reports of new or changed entries and feeds them into the PIM pipeline for enrichment and review. The canonical catalog can be updated on a scheduled basis or on demand.

The Delta Analyzer solves the problem of the catalog going stale. Without continuous synchronization, a product catalog for Cloud procurement can become stale within days. For example, new ISVs onboard to marketplaces weekly. In some implementations, a delta analyzer monitors cross-CMP catalog diff, weekly reports, and performs drift detection.

Existing vendors add new product families. Pricing changes. The Delta Analyzer runs on a schedule (e.g., daily or weekly) or on demand to detect drift between the cloud marketplace catalogs and the canonical catalog. In some implementations, the delta analyzer then feeds changes back through the full enrichment and review pipeline. The Delta analyzer cross references over different selected Cloud procurement APIs with different update frequencies and data formats.

Catalog drift is one of the operational problems in cloud marketplace procurement as Cloud marketplace catalogs are not static. Based on publicly available information there are more than 70K+product listings in 2026 for AWS, Azure and GCM marketplace listings. Across these three marketplaces, it is estimated that there are dozens of catalog changes per week (new vendors, new product families, pricing updates, deprecated listings). Without the Delta Analyzer, the canonical catalog would become stale within weeks. When the catalog drifts, the downstream impact cascades through every part of our system like Matching Accuracy degrades, Private Offer Failures if the UUID is not correlated with the marketplaces products, financial reconciliation if UUID is one of the keys used in tracking etc. So, the closed-loop nature of this (detect drift, enrich, review, approve, broadcast) is the non-trivial process. Each component alone deals with a task, but combination in this specific pipeline for cross-marketplace catalog synchronization is the highlight.

In some implementations, the catalog manager UI presents the AI-enriched fields side-by-side with the raw input, allowing the reviewer to see what the AI changed and correct errors. The reviewer can edit any field (legal name, website, logo URL, product families, aliases) before approving.

Another aspect of the LLM enrichment agent that improves the reliability of results is that the LLM Agent can be configured to return structured data in a specific schema. In this implementation, the system validates that the returned data conforms to expected types and formats before writing to staging tables. For example:
Website URLs are validated for format and reachability
Logo URLs are validated as accessible image resources
Legal names are checked for minimum length and character validity
Product family names are deduplicated against known aliases before staging

Another aspect is a prompt structure with guardrails, and explainability with regards to references. The LLM Agent uses custom prompts designed to minimize hallucination. The prompts instruct the LLM to only return information it can verify from public sources (e.g., company websites, press releases, marketplace listings). In some implementation, the prompts explicitly request that the agent indicate uncertainty rather than guess (e.g., returning null for fields it cannot confidently determine). In some implementations, the prompts include examples of correctly enriched vendors to guide the output format. The LLM enrichment agent may specifically be instructed not to fabricate product families or aliases that it cannot verify. In some implementations, cross-reference verification is performed.

After AI enrichment, the system cross-references enriched data against known marketplace catalog data. If the LLM Agent claims a vendor has a specific product family, a verification test can be performed that product family actually appears in Cloud marketplaces sch as AWS®, Azure®, or GCP® marketplace listings. Mismatches are flagged for human review.

The combination of: (a) structured prompt engineering for factual grounding, (b) schema validation on LLM output, (c) staging-to-canonical pipeline with human review, and (d) cross-marketplace verification creates a system where LLM hallucinations are caught before they can contaminate the canonical catalog.

It will be understood that the LLM enrichment engine may be implemented as a Perplexity® Agent, although more generally a wide variety of LLMs could be used. The LLM operates as a service that takes raw vendor data and returns structured enrichment. As previously discussed integration pattern is that converts raw vendor names to the Agent service, for each vendor name, the Agent constructs a structured prompt that instructs the LLM to: (a) identify the official legal name, (b) find the company website, (c) find the company logo URL, (d) identify known product families, (e) identify known aliases and trade names, prompt includes explicit instructions to: return null for any field the LLM cannot verify from public sources; never fabricate product families.

Table 1, below, illustrates an example data model with staging and Support Entities. Staging tables. indicate confidence level for each field, product family lists are deduplicated. Validated output is written to StagedVendors and StagedProductFamilies with status PENDING_REVIEW for the Human in the loop process.

TABLE 1
UUID (FUID)-Bearing Entities (carry canonical identifier):

| Vendors | Product Families |
|---|---|
| fuid, legalName, | fuid, vendorId, |
| website, logo, | name, aliases, |
| status | status |

Staging & Support Entities:

| StagedVendors | StagedProductFamilies | UploadBatches |
|---|---|---|
| rawName, | vendorId, name, status | batchId, csvUrl, |
| enrichedData, | | status, |
| status | | timestamps |
| ProductListings | Ignored Vendors | AuditLog |
| vendorId, | vendorId, reason, | entity Type, |
| productFamilyId, | ignoredAt | entityId, action, |
| marketplace | | userId |
| VendorAliases | MarketplaceSync | |
| vendorId, | marketplace, | |
| aliasName, | lastSyncAt, | |
| source | diffCount | |

A summary of some example hallucination prevention layers in a multi-step hallucination prevention process is illustrated below in Table 2. It will be understood that variations on the multi step anti-hallucination process may be implemented.

TABLE 2

| Step | Mechanism | What It Catches | Implementation |
|---|---|---|---|
| Prompt | Structured | Prevents | Custom prompt |
| Engineering | prompts with | creative | templates with |
| | explicit con- | fabrication | few-shot |
| | straints and | at gener- | examples |
| | examples | ation time | |
| Schema | Output | Catches | JSON Schema |
| Validation | validated | malformed | validation + |
| | against | output, | URL reacha- |
| | JSON | invalid | bility check |
| | schema | URLs, | |
| | with type | empty | |
| | and format | required | |
| | checks | fields | |
| Cross- | Enriched | Catches | Query Product |
| Reference | data compared | fabricated | Listings for |
| | against known | product | marketplace |
| | marketplace | families | presence |
| | catalog data | that don't | |
| | | exist in any | |
| | | marketplace | |
| Human | Catalog | Catches all | Catalog review |
| Gate | Manager | remaining | with |
| | reviews | errors: | APPROVED |
| | every | incorrect | /REJECTED |
| | enriched | legal | status |
| | entry before | names, | |
| | approval | wrong | |
| | | associations, | |
| | | subtle | |
| | | hallucinations | |

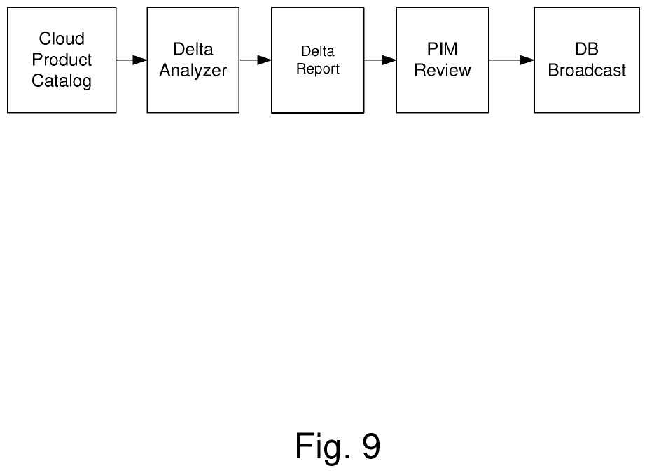

Referring to FIG. 10, some additional aspects of multilevel normalization are illustrated. The multi-layer normalization may include one or more of the following: String Normalization 1002 includes Lowercase conversion, removal of special characters, whitespace standardization, removal of common suffixes (Inc., Corp., Ltd., LLC, GmbH), and Unicode normalization to handle accented characters. Alias Resolution 1004 includes maintaining for each canonical vendor a Vendor Aliases table. When new data arrives from any source (e.g., CSV upload, Delta Analyzer, marketplace API), the system first checks whether the raw name matches any known alias before attempting to create a new entry. This prevents duplicate UUID creation for known variants. Fuzzy Matching 1006 is performed for near matches that are not exact alias hits, the system uses similarity scoring to suggest potential matches to a catalog manager. For example, “CrowdStrike Holdings” and “CrowdStrike Inc.” would receive a high similarity score and be presented as a potential duplicate for human review. Marketplace-Specific Parsing 1008 may be performed to reflect that each cloud marketplace has different conventions for how vendor and product names are structured. AWS uses publisher names, Azure uses publisher display names within offers, and GCP uses solution provider names. Marketplace-specific parsers may be used to extract the canonical vendor name from each format.

In some implementations, the matching engine accepts customer software asset data in CSV format or through enterprise systems like Coupa, ServiceNow, NetSuite etc. In this implementation, each row contains fields such as vendor name, product name, current subscription type, contract value, and contract end date. This data may be exported from the customer's procurement system, CRM, or SAM tool, and are inconsistent in naming conventions and so the cleaning and matching of the data is a complex problem that involves both automated and human in the loop processes.

A multi-step process for the normalization of Vendor Names, Vendor Aliases, Fuzzy matching (example: threshold configuration, Levenshtein length, Cosine Similarity, Embeddings) and Catalog enhancement, Marketplace availability, Recommendations, Unmatched data reconciliation in our Catalog to build a self-improving system etc.) to get the outcome to show the users to make the right decisions. Some examples of a multi-step normalization process are illustrated in Table 3, below.

TABLE 3

| | Input | Output |
|---|---|---|
| Operation | Example | Example |
| Unicode | Paló Alto | Palo Alto |
| normalization | | |
| (NFC) | | |
| Lowercase | Palo Alto | palo alto |
| conversion | Networks | networks |
| Special | palo-alto | palo alto |
| character | networks! | networks |
| removal | | |
| Suffix | palo alto | palo alto |
| stripping | networks | networks |
| (Inc., | inc | |
| Corp., | | |
| Corporation, | | |
| Ltd., Limited, | | |
| LLC, LLP, | | |
| Co., GmbH, | | |
| Company | | |
| etc.) | | |
| Whitespace | palo alto | palo alto |
| standardi- | networks | networks |
| zation | | |
| Alias | palo alto | PAN, |
| lookup | networks | PANW, |
| | | palo alto |
| | | networks |
| Fuzzy | palto alto | Candidate: |
| match | netwrks | palo alto |
| | | networks |
| | | (0.91 scoring) |

In some implementations, only Vendors and ProductFamilies (and the final products) will have the finalized UUID (FUID) enforcing the principle that the UUID (FUID) represents a curated identity, not a raw data record. As previously discussed, there is a human in the loop, to enforce the approval gate. In some implementations:
AuditLog captures previousState and newState as JSONB, enabling full traceability of every change to every entity. This supports both compliance requirements and the ability to roll back erroneous approvals.
ProductListings uses a marketplace enum (AWS, AZURE, GCP) rather than separate tables per marketplace, enabling uniform cross-marketplace queries.
IgnoredVendor uses a reason enum that forces the Catalog Manager to categorize why a vendor was excluded, maintaining institutional knowledge about namespace decisions.
Overall protocol is non-obvious because it involves technical implementation of a human-in-the-loop constraint.

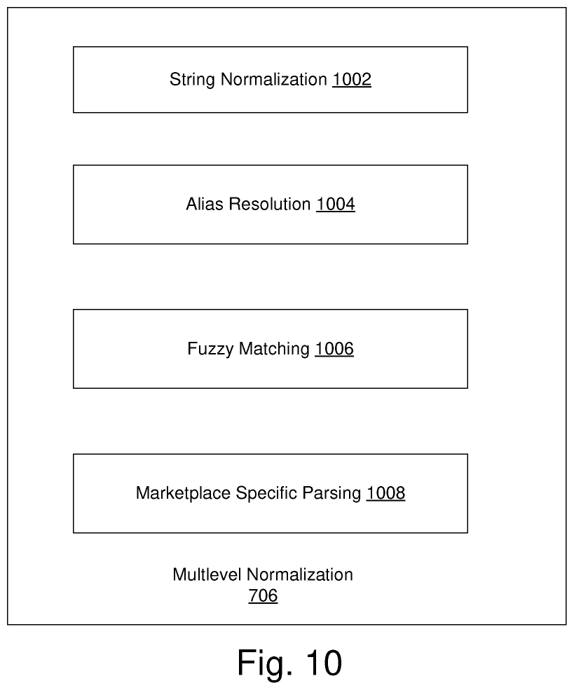

FIG. 11 is a flow chart of an example method to generate a UUID in accordance with an implementation. At block 1102, a vendor list, such as a CSV, is uploaded. At block 1104, batch processing is performed in which the CSV is parsed into batches. At block 1106, AI Enrichment is performed to match vendors with legal names, websites, logos, and product families. The enrichment data is put into staging tables. At block 1110, human review is performed, which can edit the fields of the staging tables for the UI, rejecting the UUID, or approving the UUID. At block 1112, UUID assignment to a vendor/product family records. At block 1114, the UUID is frozen (fixed in form) and broadcast and synced with one or more catalogs (e.g., production and non-production catalogs).

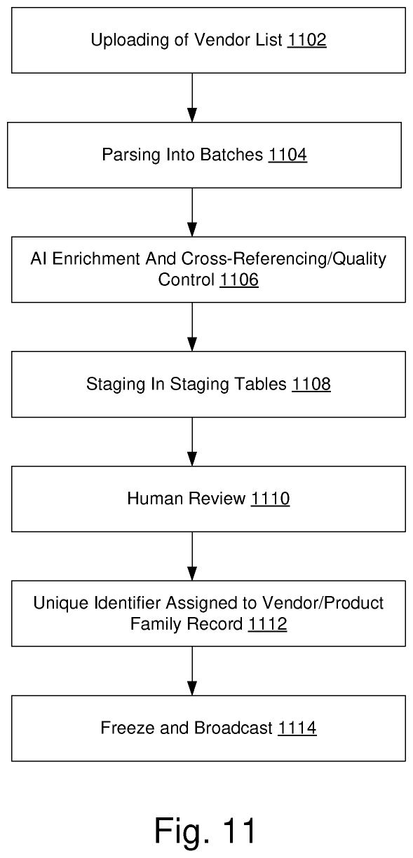

FIG. 12 illustrates, an example of a UUID that has information about vendor name variations and relationships with vendor products and vendors product IDs.

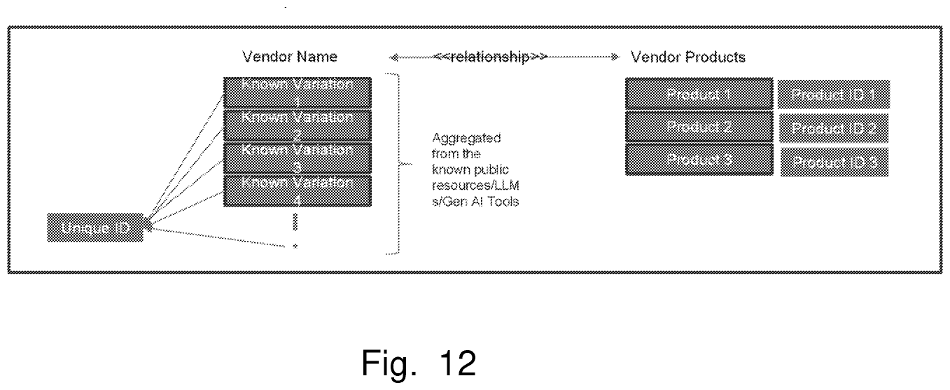

Data models to support UUID may be implemented in many different ways. In some implementations, canonical approved vendors have an ID, UUID, vendor Name, legal name, website, and aliases. Canonical approved product families have an ID, UUID, name, vendor, aliases, and logos. Other data models may support raw file tracking, batch processing, pre-approval holding areas for staged vendors, preapproval product families, audit logs etc. Referring to FIG. 13, this corresponds generally to UUID vendors bearing entities1302, UUID vendor product families bearing entities 1304, and staging and support entities 1306.

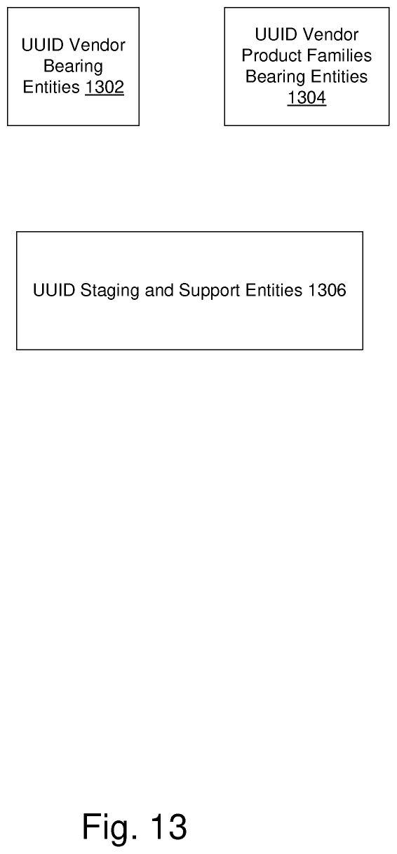

As illustrated in FIG. 14, a cross marketplace matching engine may receive a buyer's data (e.g., existing licenses, subscriptions, and contracts) and perform normalization and matching in a matching engine1404 to generate a multi-category output 1406. For example, with three Cloud product catalogs for Azure®, AWS®, and GCP®, there are seven categories of outputs such as: total matches, not matched, found on AWS®, found on GCP®, found on Azure®, expired/renewal, and total new. This sort of cross-platform matching is unique for providing buyers insight across different Cloud product platforms and for also taking into account other forms of information about the buyer.

An audit trail may be maintained to record if an UUID has been approved, rejected, or ignored. Using a combination of techniques to increase the accuracy of the UUIDs is highly beneficial. A UUID may be generated via staging pipeline that combines LLM-based enrichment from public sources, human curation, cross-marketplace alias resolution, continuous delta (drift) analysis, and an audit trail. The combination of techniques ensures that UUIDs are generated in a reliable and accurate manner. It addresses the problem that each Cloud Procurement marketplace platform has different naming conventions. For example, AWS uses “seller/publisher” with an AWS®-specific seller ID; Azure® uses “publisher display name” within Offers; GCP® uses “solution provider name.”

The UUID is a technical innovation that enables cross-platform abstraction. When a vendor data is enriched and approved through our PIM pipeline, the resulting UUID becomes a Cloud platform-independent identity that persists regardless of which marketplace the vendor or product appears on. This is fundamentally different from using any single marketplace's internal IDs (which are siloed) and also differs from maintaining a simple lookup table (which does not carry the curated, AI-enriched context).

### Intelligent Product Display Pages (IPDP)

Consider as an example an incoming query for a product search. In some implementations, the query is normalized. A relationship table or other mapping structure may be used for the UUID to find matches against any of the stored alternative names in the different cloud marketplaces. If a match is found, the system returns the corresponding UUID, which can then be used to retrieve other product details This may include retrieving product listing pages. This approach allows efficient searching across multiple naming conventions while maintaining data integrity and avoiding duplicate entries. The UUID is carried throughout the procurement process. The Product Listing Pages (PDP's) on the meta-marketplace will have associated UUIDs and these UUID references will be carried throughout the transaction process into the cloud marketplaces and into the procurement and finance systems (analogous to the purchase order numbers which are used to reconcile the marketplace spend in the FP&A systems). The UUID references are carried throughout product display pages, private offer creation and acceptance, purchase order generation, financial reconciliation.

There are a variety of ways intelligent product display pages can be built. One approach is to build product display pages for each ISV. The product display pages are based on ISV data. Each ISV and their associated products are an associated UUID. The product display pages are “intelligent” in the sense that that be tracked using, for example tracking tools based on tag. The product display pages can have analytics. In some implementations, a process for building an intelligent product display includes receiving product information from an ISV, building a product display page for the ISV, associating a UUID with the product display page, and tracking buyer behavior associated with the product display page. Analytical data may be provided to the ISV, including data indicative of buyer intent.

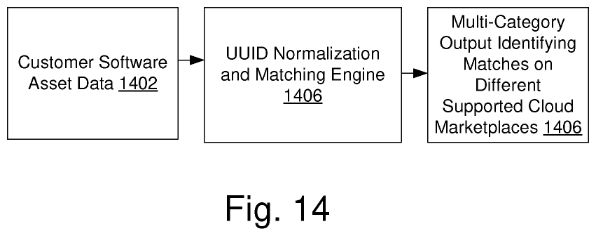

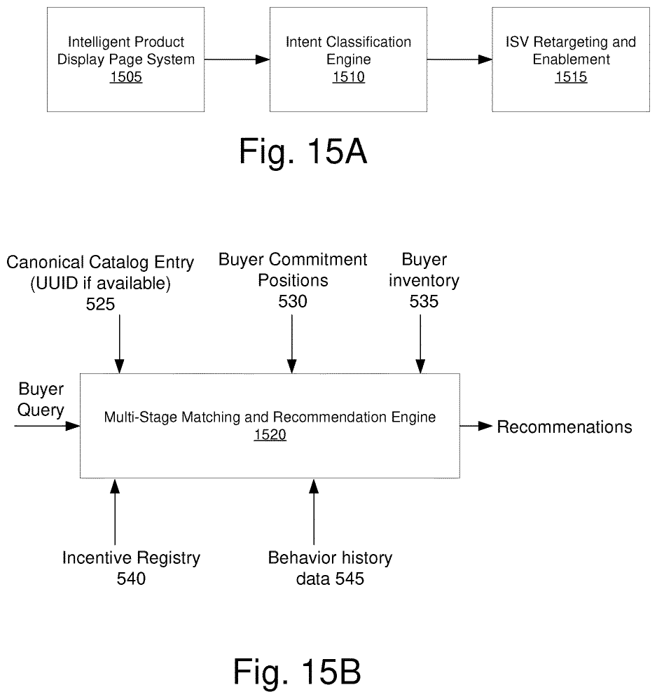

Referromg to FIG. 15A, in some implementations, an IPDP system 1505operates on the buyer side (Compass) to capture buyer signals for information such as search queries, page interactions, scroll depth, feature comparisons, and click paths. These signals are fed into an intent classification engine 1510. As some examples, the IPDP system can classify the buyer's intent into various buckets. An exploratory classification corresponds to a buyer browsing and doing early research. A comparative classification corresponds to a buyer performing feature comparison and price analysis. A transactional classification corresponds to the buyer being ready to purchase (that is with a high-intent to buy signals). Another example classification is renewal, for an existing subscription nearing expiration. These are four examples of useful classification. It would be understood that a different set of classification could be used. Moreover, it would be understood that the criteria for mapping captured buyer signals to categories may be selected in various ways, such by classifying the buyer signal heuristically or by machine learning techniques. In some implementations, when a high intent to buy is detected, this is used to initiate ISV retargeting and enablement 1515.

In one implementation of intent detection, the system classifies the buyer's action into one of four intent categories:
Exploratory: Buyer is browsing categories, viewing multiple product families. System responds with broad cross-marketplace availability and general pricing tiers.
Enrichment: Enriching the specific products' data per marketplace availability differences and pricing benchmarks based on our curated data sets and also the third-party integrations that will provide additional benchmarking data sets.
Transactional: Buyer has selected a product and is viewing offer details or requesting a quote. System responds with commitment-optimized recommendations and incentive-maximized pricing.
Renewal: Buyer has an existing subscription nearing expiry. System responds with renewal optimization including cross-marketplace rebalancing options (if the user chooses to but the entire decision-making is for the user to decide based on what the system curates and presents as Decision support system).

FIG. 15B illustrates an example of a multi-stage matching and recommendation engine 1520 in accordance with an implementation. In some implementations, when a buyer interacts with Compass, the system processes queries through a multi-stage internal processing that combines catalog data, enterprise commitment context (if available) and if not available the system shows the matches based on the input data alone, and behavioral signals collected over a period time for the user or company in context (This will be the additional Machine Learning and Data Analysis etc. which we have to design and build with the evolution of the system):

To respond to a buyer query, the system assembles the available contextual information regarding a canonical catalog entry 525, buyer commitment position 530 (if available), buyer inventory 535 (if available), an incentive registry 540 (if available), and behavioral history 545 (if available).

In some implementations, the recommendation engine 1520 performs a variety of complex technical actions (inventory cross-referencing, commitment balance calculation, multi-factor optimization), as well as supporting procurement private offers, incentives, and reconciliation of the spend data for the customer.

Table 4, below, illustrates some examples of data source, fields retrieved, and use in generating a buyer recommendation.

TABLE 4

| Data | Fields | How Used in |
|---|---|---|
| Source | Retrieved | Recommendation |
| Canonical | product | Identifies which |
| Catalog | family | product the |
| Entry | FUID, | buyer is asking |
| (FUID as | marketplace | about; links to all |
| available) | availability | marketplace- |
| | (AWS/ | specific listings |
| | Azure/GCP), | |
| | product | |
| | category | |
| Buyer | EDP | Determines which |
| Commitment | balance + | marketplace to |
| Positions | expiry, MACC | recommend for |
| | balance + | routing; calculates |
| | expiry, GCP | commitment |
| | committed | burn impact |
| | use balance + | |
| | expiry | |
| Buyer | Current | Identifies renewal |
| Inventory | software | opportunities; |
| | subscriptions, | prevents duplicate |
| | contract end | purchases; |
| | dates, usage | suggests |
| | metrics, | consolidation |
| | cost center a | |
| | llocation | |
| Incentive | Active CMP | Calculates total |
| Registry | programs, ISV | incentive value |
| | promotions | per marketplace |
| | (from Beacon), | route; ranks |
| | CP pricing, | options by net |
| | meta- | savings (which |
| | marketplace | we are evalu- |
| | credits | ating in the |
| | available | future). |
| Behavioral | Past searches, | Personalizes |
| History | viewed products, | recommendations; |
| | previous | identifies products |
| | purchases, time- | buyer has |
| | on-page | shown repeated |
| | by product | interest in |

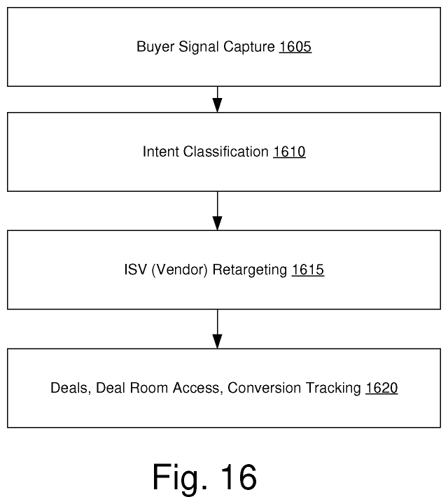

FIG. 16 is an example of a flowchart. In block 1605, buyer signals are captured, where these may include various types of buyer behavior. Intent classification is performed in block 1610. ISV (vendor) retargeting is performed in block 1615. This may lead to the vendor initiating deal or deal room access, as well as conversion tracking 1620.

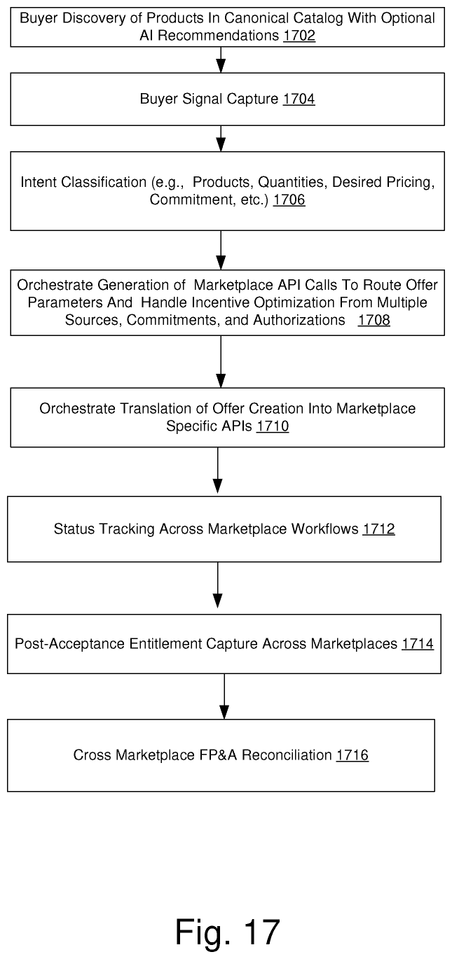

FIG. 17 is a flowchart of a more complex example. At block 1702, there is buyer discover of products in a canonical catalog with optional AI recommendations. At block 1704, there is a buyer signal capture as the buyer navigates product display pages. There is intent classification of buyer behavior in block 1706. The intent classification can be based on how a user navigates product display pages. It can also take into account other factors related to what the user is searching for and previous history, inventory, and commitments. At block 1708 there is an orchestration of marketplace API calls to route vendor offer parameters and support incentive optimization from different sources, account for commitments, and authorizations. At block 1710, there is status tracking across marketplace workflows. At block 1712, there is post-acceptance entitlement capture. At block 1714, there is FPA reconciliation.

As illustrated by FIG. 17, the abstraction layer and use of cross-platform API integrations, workflow translations, and cross-platform orchestrations support new forms of procurement.

### Commitment-Aware Procurement Routing.

In some implementations FinOps integration system with commitment planning is used. Enterprise customers typically have financial commitments with cloud providers, such as for example Enterprise Discount Programs (EDPs) on AWS, Microsoft Azure Consumption Commitments (MACCs), and Google Cloud's committed use discounts. These commitments have spend floors that must be met within a contract period.

In some implementations, the meta-marketplace factors these commitments into procurement decisions at the point of transaction, not after the fact. For example, when a buyer browses products on Compass, the system can recommend routing a purchase through a specific marketplace to help the buyer meet their commitment obligations. For example: suppose a buyer has $500K remaining on an AWS® EDP with 3 months left. In this example, the system recommends routing eligible purchases through AWS Marketplace to burn down the commitment. Suppose instead that the buyer has already met their AWS @commitment but is behind on Azure® MACC In this case, the system recommends Azure for the same product, if available on Azure®. In some implementation, the system models the financial impact of each routing decision, showing estimated savings or commitment gap implications. However, the recommendations and financial impact modeling may be provided as options for the customer to consider.

As another example, suppose a buyer uploaded the inventory of SaaS contracts. In this example, system matches the products cross-marketplace availability which then analyzes the buyer's commitment balances (EDP remaining, MACC remaining, GCP® committed use remaining) and surfaces contextual recommendations.

### UUID-Based Financial Reconciliation

Persisting the UUID through the entire transaction lifecycle enables financial reconciliation in which FP&A teams can reconcile marketplace invoices against purchase orders because the UUID links the procurement decision to the financial transaction, Chargeback reconciliation (allocating cloud spend to specific departments or cost centers) becomes accurate because UUID provides the product-level granularity needed for allocation. The system enables automated reconciliation by tagging every transaction with UUID at the point of procurement, creating a consistent identifier that persists through the financial lifecycle and helping in the financial reconciliation.

UUID-tagged transactions can be routed to flow into the FinOps module. These supports reconciling the marketplace invoice (which uses marketplace-specific product IDs) against the original procurement decision (which used UUID).

Chargeback allocation routes the cost to the appropriate department/cost center based on UUID-to-department mapping.

In contrast, current FinOps tools are structured to analyze spending after the transaction has occurred. Our system is fundamentally different: it optimizes before the transaction.

Cross-Marketplace FP&A Reconciliation: This is a new workflow that does not exist in any current procurement tool. Today, FP&A teams reconcile cloud marketplace spend manually by downloading reports from each marketplace portal, cross-referencing vendor names (which differ across marketplaces), and manually mapping to internal cost centers. This is error-prone and time-consuming.

### Delivery, Acceptance, and Entitlement

In some implementations, the buyer receives the offer through marketplace-specific channels (URL for AWS®, email link for Azure®, Marketplace console for GCP®) which is provided in Compass for the Buyers to accept. In some implementations the system tracks offer status across all marketplaces for the private offers submitted to the Buyers on our platform. The entitlement feeds into inventory management (Compass), financial reconciliation (FP&A integration), and CRM sync as needed. The UUID-tagged transaction flows into the FinOps module.

### Incentive Optimization

Incentives can be thought of as a general bucket and the meta-marketplace platform can fill that bucket with various incentives based on the availability and on a case-by-case basis or general availability for everyone. These will change based hyperscaler and ISV evolutions and new mechanisms in the future (bundling etc. are not covered here but can be one of them). First, the meta-marketplace system uniquely optimizes across incentives such as Cloud Provider Incentives. Each marketplace offers programs that provide credits, co-sell benefits, or reduced fees. AWS® ISV Accelerate provides co-sell support and cash incentives. Azure® co-sell incentivized offers receive marketplace rewards. GCP® has partner incentive programs with backend rebates. These changes frequently and our system tracks current program eligibility. Second, the meta-marketplace optimizes over ISV Incentives via Beacon. In some implementations, ISVs configure incentive campaigns in Beacon. This may include volume discounts, multi-year pricing, bundle pricing, or promotional credits. These are typically ISV-controlled. In some implementations, the meta-marketplace system layers these on top of marketplace-specific pricing. Third, in some implementation there are meta-marketplace credits. That is the meta-marketplace platform credits provide an additional incentive layer that can offset transaction costs, reward loyalty, or bridge commitment gaps. Fourth, Hyperscaler account teams offer incentives if they want to entice the buyer to complete the transaction on the Hyperscaler marketplace (these are case by case basis). Fifth, Hyperscaler migration credits. These are the infrastructure credits that Hyperscalers offer to offset some of the buyers' costs when they go through migration planning and execution. In some implementations, the incentives are optimized in a comprehensive manner to account for all the various incentive opportunities, or a subset of the various incentive opportunities.

This is a combinatorial optimization problem that existing tools do not solve because they may lack visibility into all these simultaneously or may not have mechanisms to capture all these in a curated way for the customers. Cloud provider tools see only their own incentives. ISV tools see only their own pricing. FinOps tools see only commitment balances. Our system is the only point where all look into different dimensions.

### AI Context-Aware Deal Recommendations

In some implementations, aa AI Deal Assist operates with context of one or more different types of buyer information. This may include the buyer's current software inventory (mapped via UUID to the canonical catalog). It may include contextual information on the buyer's commitment positions across different Cloud procurement marketplaces. The context may include the buyer's historical procurement patterns (which marketplaces they prefer, typical deal sizes, renewal cycles). The context may include the current incentive landscape (which marketplace programs are active, which ISV promotions are running). Having extensive context means the AI can make recommendations like: “You have $200K remaining on your AWS EDP expiring in 90 days. Your Palo Alto Networks renewal is coming up. Routing this through AWS Marketplace would burn $180K of your commitment and qualify for an ISV Accelerate co-sell credit.” No existing tool produces this kind of cross-dimensional recommendation in my view.

In some implementations, an Agentic AI tool automates complex procurement scenarios. Examples include Automated license optimization. In automated license negotiation, the AI analyzes current software usage and recommends rightsizing or consolidation across marketplace offerings. Another example of a complex procurement scenario is using AI for predictive commitment management. In this example, AI forecasts commitment burn rates and proactively recommends procurement actions to avoid shortfalls.

In some implementations, AI is used for Deal Room negotiation support. In this implementation, AI assists ISVs in structuring offers based on buyer intent signals and competitive dynamics to convert intent to transaction.

### Multi-Account and Multi-Tenant Management

Enterprise buyers typically have multiple AWS accounts, multiple Azure tenants, and multiple GCP billing accounts. Each marketplace associates private offers and entitlements with specific accounts/tenants. Our system manages the mapping between a buyer's organizational identity and their marketplace-specific accounts, ensuring offers are routed to the correct account and entitlements are captured across all accounts.

In some implementations, the abstraction layer aids in complying with a Reseller Authorization Chain. When transactions flow through Channel Partners, the authorization chain differs per marketplace. For example, AWS requires the ISV to explicitly authorize a specific Channel Partner, who then creates CPPOs. Azure requires the ISV to configure their offer for reseller access, and the CP extends through the Partner Center. GCP requires partner plan configuration and reseller offer setup.

In some implementations, the system tracks the authorization status of ISV for Private Offer (PO) as this is the pre-requisite for the Hyperscaler Private Offers. This complexity is abstracted by the meta-marketplace platform.

### Example UUID Platform Architecture

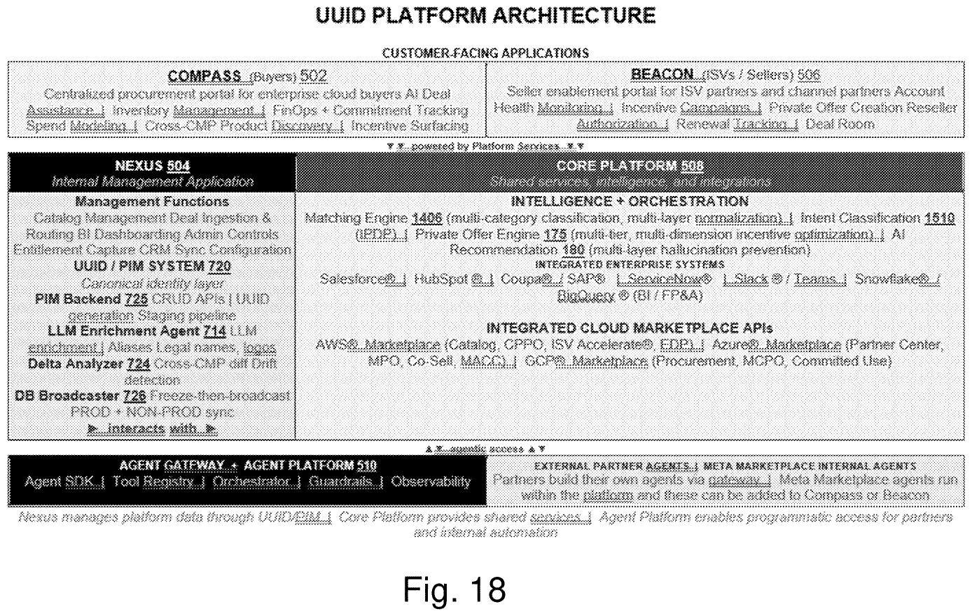

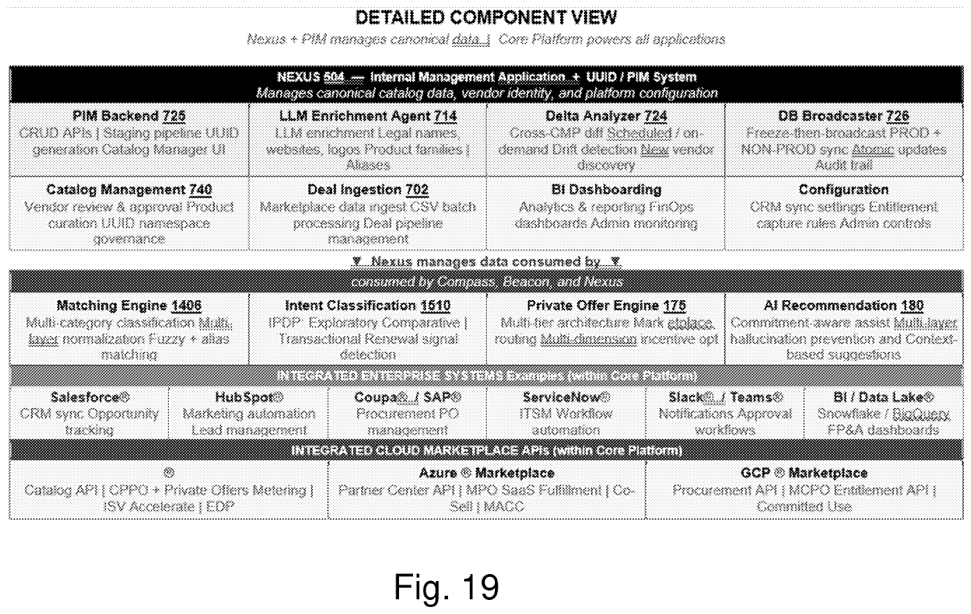

The overall UUID platform architecture may be implemented in a variety of different ways. FIG. 18 illustrates an example of features and functions of an architecture having Compass 502 and Beacon 506 as the customer-facing applications, Nexus 504 as the international management applications, the core platform 508, and optional agentic AI support 510. Nexus, for example, in this implementation is responsible for managing a variety of function including the UUID PIM system 720, the PIM Backend, 725, the LLM Enrichment agent 714, the delta analyzer 724, and the DB broadcaster 726. The core platform 508 in some implementation provide intelligence and orchestration functions, such as the matching engine 1406, and intent classification 1510, private offer engine 175, AI recommendation engine 180. FIG. 19 illustrates a detailed component view, as well as illustrating possible integrations with various software services and with various Cloud marketplace APIs.

### Infrastructure Support Examples

In some implementations, the meta-marketplace is implemented as a multi-tenant SaaS platform, an infrastructure orchestration is purpose-built. In some implementations, a CSV ingestion system uses AWS S3 pre-signed URLs for secure, scalable file upload. This allows untrusted vendor data to be securely deposited into a processing pipeline without exposing internal storage endpoints. The pre-signed URL has a time-bound expiry and is scoped to a specific batch operation. In some implementations, batch processing is performed with Limit/Offset Pagination. For example, a CSV parser may use a scalable batch architecture with configurable limit/offset pagination. For example, in some commercial-scale vendor catalogs where a single CSV may contain thousands of vendor rows. The batch processor manages state transitions (QUEUED, PROCESSING, COMPLETED) and can be parallelized across multiple processing nodes.

In some implementations, the DB Broadcaster component maintains synchronized copies of the canonical catalog across production and non-production environments. This requires a database replication architecture that ensures transactional consistency and can also have a human in the loop element to ensure the consistency in the information relay. A freeze-then-broadcast pattern is used, where the catalog is locked, the broadcast is executed atomically, and environments are verified before the lock is released.

A cross-marketplace API Gateway Layer may be implemented as a backend engine from gathers the information from the connections to different distinct cloud marketplace APIs (e.g., AWS Marketplace, Azure Commercial Marketplace, Google Cloud Marketplace). The APIs are accessed only when the hyperscalers give access and Each has different authentication mechanisms, rate limits, and data formats. In some implementations, the system includes marketplace-specific API adapters with circuit breakers, retry logic, and rate-limit-aware throttling.

In some implementations, an interconnected processing engine including a batch ingestion subsystem, an AI enrichment engine, a staging database, a human review interface, and a multi-environment broadcasting subsystem.

The use of an LLM Agent to generate enriched data solves this by discovering the legal name, known aliases, website, and logo for each raw vendor entry. The human reviewer then confirms or corrects this enrichment before UUID is assigned. This means a single UUID ties together all marketplace-specific aliases for one canonical vendor identity.

### Additional Implementation Examples

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

To ease description, some elements of the system and/or the methods are referred to using the labels first, second, third, etc. These labels are intended to help to distinguish the elements but do not necessarily imply any particular order or ranking unless indicated otherwise.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes but is not limited to firmware, resident software, microcode, etc. Furthermore, the technology can take the form of a computer program object accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and Modems, are just a few examples of network adapters. The private and public networks may have any number of configurations and/or topologies. Data may be transmitted between these devices via the networks using a variety of different communication protocols including, for example, various Internet layers, transport layers, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A method of cataloging Cloud procurement marketplaces comprising:
monitoring, for a plurality of Cloud product catalogs of different Cloud marketplaces, vendor names and vendor product naming;
generating unique identifiers, with each unique identifier defining a vendor name. and associated vendor alias names in different Cloud procurement marketplaces, and describing a relationship with vendor product names and vendor product families in different Cloud procurement marketplace platforms;
generating a canonical product catalog for the plurality of Cloud procurement marketplaces using a schema based on the unique identifiers;
updating the common product catalog in response to detecting changes in vendor names or vendor product information in the plurality of different Cloud procurement marketplaces;
supporting at least one procurement action using the canonical product catalog and automatically handling differences in how different Cloud procurement marketplace platforms interact with buyers and sellers in procurement transactions.

2. The method of claim 1, wherein generating a new unique identifier comprises normalizing vendor and product information, including performing string normalization, alias resolution, fuzzy matching, and marketplace specific parsing.

3. The method of claim 2, wherein generating the set of unique identifiers comprises: utilizing a large language model to discover information on vendor legal names, vendor websites, vendor logos, and vendor product families, the large language model provided with guardrail prompts; and performing cross-reference validations of the information provided by the large language model.

4. The method of claim 3, wherein generating the set of unique identifiers comprises performing a staged sequence of operations including parsing vendor information, normalizing vendor names, enriching vendor and product information using the large language model; generating candidate unique identifiers, and performing human review of the candidate unique identifier as a condition to generating a unique identifier.

5. The method of claim 4, where generating the set of unique identifiers includes using a staging pipeline with structured staging tables.

6. The method of claim 1, further comprising handling, via an abstraction layer, differences between Cloud marketplace in Application Programming Interfaces (APIs), data models, terminology, workflows, and product catalog naming conventions.

7. The method of claim 1, further comprising: generating trackable product display pages for sellers, and classifying buyer intent from buyer interactions with one or more product display pages.

8. The method of claim 7, further comprising, initiating a private offer between a seller and a buyer.

9. The method of claim 7, further comprising: generating recommendations to the buyer based on at least one of cross Cloud marketplace commitments, buyer inventory, and previous buyer behavior.

10. The method of claim 7, further comprising performing marketplace routing for procurement, based on the captured intent, and performing offer configuration and translation from a private offer workflow of a Cloud marketplace platform into a Cloud Platform agnostic workflow.

11. A method of performing procurement across different Cloud platforms comprising:
generating a searchable catalog with unique identifiers defining vendor names and vendor product names that account for differences in vendor naming and differences in product naming for a plurality of different Cloud procurement marketplaces;
receiving a prospective buyer's procurement search query;
generating a multi-category output identifying matches for the buyer's query in the different Cloud procurement marketplaces;
wherein centralized procurement is supported across the plurality of different Cloud procurement marketplaces.

12. The method of claim 11, further comprising providing an artificial intelligence agent to assist the buyer with a procurement deal.

13. The method of claim 11, further comprising performing inventory management for the buyer, and providing, to the buyer, procurement recommendations based on the buyer's inventory.

14. The method of claim 11, further comprising tracking buyer commitments and generating procurement recommendations based on the commitments.

15. The method of claim 11, further comprising performing FinOps tracking for the user based on the unique identifiers.

16. The method of claim 11, further comprising tracking signals indicative of buyer intent and classifying the signals to identify buyer intent.

17. The method of claim 16, further comprising providing information on buyer intent to at least one vendor.

18. The method of claim 16, further comprising performing cross-platform API integrations and cross-platform orchestration to coordinate a vendor initiating a private offer to the buyer.

19. The method of claim 16, further comprising performing cross-platform API integrations and cross-platform orchestration to coordinate a vendor initiating a private offer to the buyer.

20. The method of claim 11, further comprising maintaining a unique identifier of a procurement decision throughout an entire procurement cycle.
